(19) United States
(12) Patent Application Publication
(10) Pub. No.: US 2007/0039497 A1
(43) Pub. Date: Feb. 22, 2007

(54) Printer

(75) Inventors: Anthony D. Studer, Albany, OR (US); Kevin D. Almen, Albany, OR (US); Kevin E. Swier, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard development Company LP

(21) Appl. No.: 11/208,475

(22) Filed: Aug. 19, 2005

(51) Int. Cl. B41K 1/56

(52) U.S. Cl. 101/405; 101/368

(57) ABSTRACT

Various embodiments of a printer including an actuation member are disclosed.

### BACKGROUND

Handheld printers are sometimes used to print labels and other indicia upon objects. Such handheld printers may utilize complex and expensive drive mechanisms or may lack a sufficiently compact size for ease of use and storage.

### BRIEF DESCRIPTION OF THE DRAWINGS

FIG. 1 is a schematic illustration of an embodiment of printer according to one example embodiment.

FIG. 2 is a perspective view of another embodiment of the printer of FIG. 1 according to an example embodiment.

FIG. 3 is a sectional view of the printer of FIG. 2 according to one example embodiment.

FIG. 4 is a sectional view of the printer of FIG. 2 according to one example embodiment.

FIG. 5 is a fragmentary perspective view of the printer of FIG. 2 illustrating a print device in a first position according to one example embodiment.

FIG. 6 is a fragmentary perspective view of the printer of FIG. 2 illustrating the print device in a second position according to one example embodiment.

FIG. 7 is a fragmentary perspective view of another embodiment of the printer of FIG. 1 according to an example embodiment.

FIG. 8 is a fragmentary perspective view of another embodiment of the printer of FIG. 1 illustrating a print device in a first position according to an example embodiment.

FIG. 9 is a fragmentary perspective view of the printer of FIG. 8 illustrating the print device in a second position according to an example embodiment.

FIG. 10 is a fragmentary perspective view of another embodiment of the printer of FIG. 1 illustrating a print device in a first position according to an example embodiment.

FIG. 11 is a fragmentary perspective view of the printer of FIG. 10 illustrating the print device in a second position according to an example embodiment.

FIG. 12 is a fragmentary perspective view of another embodiment of the printer of FIG. 1 illustrating a print device in a first position according to an example embodiment.

FIG. 13 is a fragmentary perspective view of the printer of FIG. 12 illustrating the print device in a second position according to an example embodiment.

### DETAILED DESCRIPTION OF EXAMPLE EMBODIMENTS

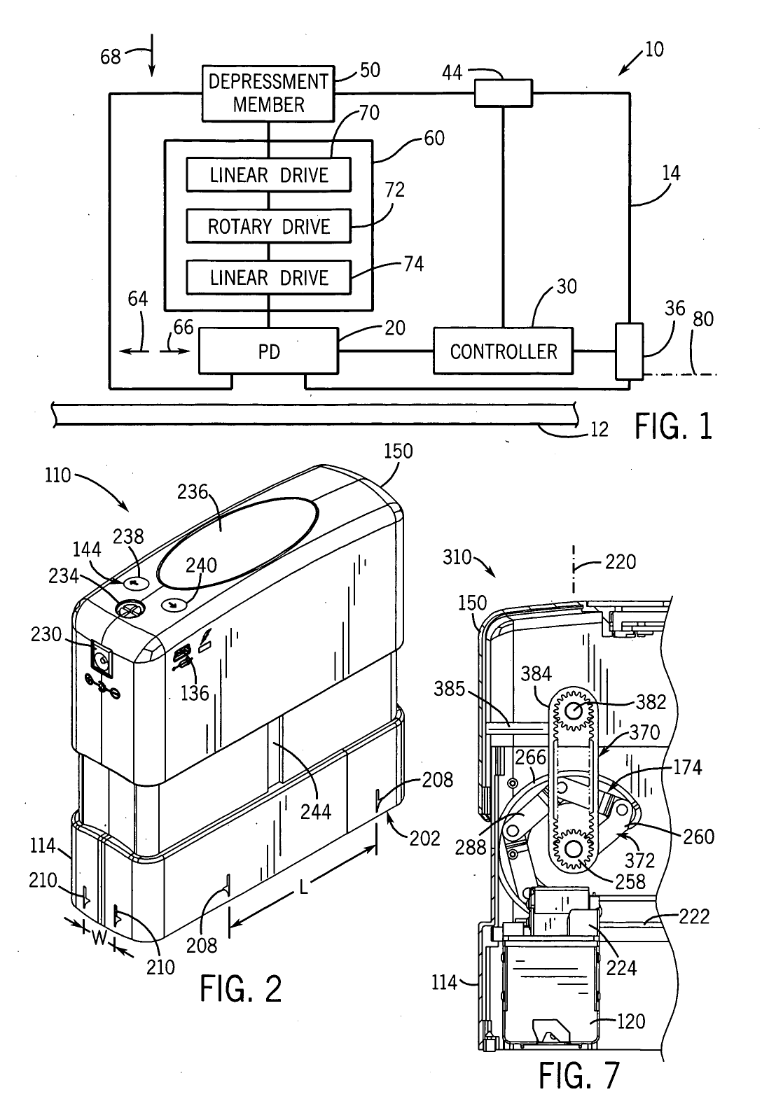

FIG. 1 schematically illustrates printer 10 which is configured to print one or more printing materials upon a medium 12. Printer 10 generally includes housing 14, print device 20, controller 30, data interface 36, user interface 44, manual actuation member 50 and transmission 60. Housing 14 constitutes one or more structures configured to support, house, and/or contain the remaining components of printer 10. In one embodiment, housing 14 is sized and shaped so as to be held and grasped by a hand of a user. In other embodiments, housing 14 may have other configurations.

Print device 20 is a device configured to interact with media 12 so as to form an image or indicia upon medium 12. In one embodiment, print device 20 includes an inkjet printhead configured to deposit ink upon medium 12. In other embodiments, print device 20 may comprise other devices configured to print or deposit printing material upon medium 12 or so as to interact with medium 12 in other fashions to form images upon medium 12.

Print device 20 is movably coupled to housing 14 so as to be movable relative to housing 14 and relative to medium 12. In one embodiment, print device 20 is movably coupled to housing 14 so as to be linearly movable in the direction indicated by arrows 64 and 66. For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

In one embodiment, print device 20 may be movably supported along a rod or other guide structure coupled to housing 14. In yet another embodiment, print device 20 may include one of a projection and a groove while housing 14 includes the other of a projection and a groove, wherein the projection is received within the groove to facilitate sliding of print device 20 relative to housing 14. In one embodiment, print device 20 may include an ink cartridge and carriage structure connected to the cartridge and movably connected to housing 14. In yet another embodiment, print device 20 may include an ink cartridge that is directly movably connected to housing 14.

Controller 30 comprises a processing unit configured to generate control signals for directing printing by print device 20. For purposes of this disclosure the term “processing unit” shall mean a presently or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Controller 30 is not limited to any specific combination of hardware circuitry and software, nor to any particular source for the instructions executed by the processing unit.

In one embodiment, controller 30 receives data via an external interface 36 supported by housing 14 and electrically connected to controller 30. In one embodiment, interface 36 is configured to be electrically connected to an external data source such as an external computer, camera and the like via a cable or wire. In yet another embodiment, interface 36 is configured to communicate with external data sources such as computers, cameras and the like in a wireless fashion. In yet other embodiments, interface 36 may be omitted where it has a memory which includes one or more images that may be printed by print device 20.

Manual actuation member 50 constitutes one or more structures movably supported by housing 14 and configured to be manually depressed or pulled by a person's finger or hand. Manual actuation member 50 receives force from a person's hand, wherein the force is transmitted by transmission 60 to print device 20 so as to move print device 20. In one embodiment, manual actuation member 50 may constitute a button, pad or similar structure movably positioned along a portion of housing 14. In one embodiment, member 50 may extend along a top of housing 14. In another embodiment, member 50 may be located on an end or side of housing 50. In one embodiment, manual actuation member 50 may cover an entire or a substantial portion of a top of printer 10 such as by extending over or nesting within housing 14.

Transmission 60 transmits force manually applied to manual actuation member 50 to print device 20 so as to move print device 20 relative to medium 12. In one embodiment, transmission 60 is configured to apply force to print device 20 such that print device 20 linearly moves relative to medium 12 substantially parallel to medium 12. In one embodiment, transmission 60 is configured to transmit force to print device 20 in a direction so as to cause print device 20 to move in the same direction. In one embodiment, transmission 60 is configured such that movement of manual actuation member 50 in the direction indicated by arrow 68 by a first distance results in print device 20 linearly moving relative to medium 12 by a second greater distance. In other words, transmission 60 may serve as a distance multiplier. As a result, print device 20 may be moved or scanned across a medium with less depressment of manual actuation member 50, enabling printer 10 to be more compact.

In the particular example illustrated, transmission 60 includes linear drive 70, rotary drive 72 and linear drive 74. Linear drive 70 is connected to manual actuation member 50 and transmits force applied to manual actuation member 50 in the direction generally indicated by arrow 68, substantially perpendicular to medium 12, to rotary drive 72. In one embodiment, linear drive 70 may include a rack gear configured to be moved or driven upon depressment of manual actuation member 50. In another embodiment, linear drive 70 includes a belt or other device configured to linearly transmit force from manual actuation member 50 to drive member 72.

Rotary drive 72 includes one or more members configured to be rotatably driven in response to receiving force from linear drive 70. In one embodiment, rotary drive 72 may include a pinion gear. In other embodiments, rotary drive 72 may include a rotary member such as a pulley, sprocket and the like. Rotary drive 72 transmits force to linear drive 74.

Linear drive 74 includes one or more members configured to convert rotational force or torque received from rotary drive 72 to a linear force so as to linearly move print device 20 along axis 80 in either direction 64 or 66. Because transmission 60 includes linear drive 70, rotary drive 72 and linear drive 74 which cooperate with one another to transmit and convert a first linear force applied in a first direction to a second linear force substantially perpendicular to the first linear force, transmission 60 may be more compact. In addition, because linear drive 70, rotary drive 72 and linear drive 74 may be further configured to cooperate with one another to provide distance multiplication, moving print device 20 a first distance in response to movement of manual actuation member 50 a second lesser distance, transmission 60 and printer 10 may be even further compact in nature.

In one embodiment, linear drive 74 may include a flexible drive member. For purposes of this disclosure, the term “flexible drive member” shall mean any member or members arranged so as to flex, bend, or change shape while transmitting force. Examples of flexible drive members include endless belts, cables, ropes, cords and the like, chains, links, and similar structures including multiple (and nominally at least three) segments which pivot or are otherwise movable relative to one another, bands, cords, strips and other elongate structures having ends and formed from materials such that such structures have sufficient stiffness or rigidity so as to transmit force yet having sufficient flexibility or bendability so as to bend at least 90 degrees about an axis. In one embodiment, such ended members are bendable at least 180 degrees about an axis while transmitting force. Because transmission 60 includes a flexible drive member, transmission 60 may transmit manual force from manual actuation member 50 to print device 20 with a more compact and less complex series or arrangement of components. As a result, printer 10 may also be more compact and less complex.

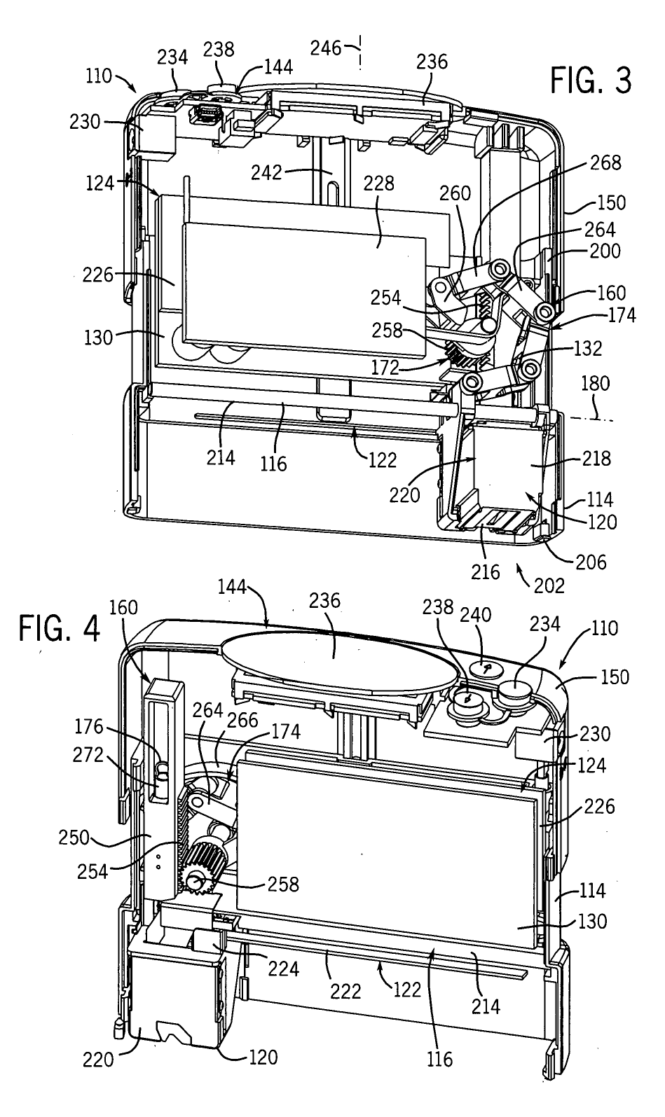

FIGS. 2-6 illustrate printer 110, one example of printer10. As shown by FIGS. 2-4, printer 110 generally includes housing 114, guide 116, print device 120, position sensor 122, power source 124, controller 130, interconnect 132, data interface 136 (shown in FIG. 2), user interface 144, manual actuation member 150, and transmission 160. Housing 114 is a structure supporting and partially containing the remaining components of printer 110. In the particular example illustrated, housing 114 has an upper end 200 slidably received within manual actuation member 150 and a lower end 202 configured to be positioned against a medium such as medium 12 shown in FIG. 1. Lower end 202 includes feet 206 (shown in FIG. 3) and print area indicators 208, 210 (shown in FIG. 2). Feet 206 constitute elastomeric members configured to be positioned against a medium to facilitate proper spacing of print device 120 from an underlying medium. Print area indicators 208 are indicia such as notches, grooves, projections, marks, printing and the like configured to indicate to a user of printer 110 a length dimension L along which printing can be formed by printer 110. Print area indicators 210 are similar to print area indicators 208 except that print area indicators 210 indicate a width dimension W along which printing may be performed by printer 110. In other embodiments, other indicia or structures may be used to indicate to a user the area of the underlying medium that may be printed upon by printer 110. In still other embodiments, feet 206 and indicators 208, 210 may be omitted.

Guide 116 is a mechanism configured to guide or direct movement of print device 120 relative to housing 114 and relative to an underlying medium. In the particular example illustrated, guide 116 is configured to guide linear movement of print device 120 along an axis 180 that is substantially parallel to a face of print device 120 and/or a plane of a face of a medium to be printed upon by printer 110. In the particular example illustrated, guide 116 includes an elongate support rod 214 slidably supporting print device 120 for movement along axis 180. Support rod 214 has opposite ends affixed to housing 114. In other embodiments, guide 116 may have other configurations. For example, in another embodiment, guide 16 may include one of a projection and a groove coupled to housing 114 and the other of a projection and a groove coupled to print device 120, wherein the projection is received within the groove and guides linear movement of print device 120 along axis 180.

Print device 120 constitutes a device configured to print indicia, pattern, image and the like Upon a medium. In one embodiment, print device 120 constitutes a device configured to deposit a printing material or other material upon a medium. In another embodiment, print device 120 constitutes a device configured to otherwise interact with a medium such that a pattern, image and the like is formed upon a medium. For example, in another embodiment, print device 120 may be alternatively configured to selectively apply heat or pressure to a medium, wherein the medium is configured such that the application of heat or pressure results in an image, pattern or indicia being formed on or in the medium. In the particular example illustrated, print device 120 includes an inkjet printhead 216 (shown in FIG. 3) configured to deposit ink or other fluid material upon a medium. In the particular example illustrated, print device 120 additionally includes an ink supply 218, wherein printhead 216 and supply 218 form a cartridge 220 removably mounted to guide 116. In yet another embodiment, printhead 216 or cartridge 220 may be fixedly or permanently coupled to guide 116 as part of printer 110.

Position sensor 122 constitutes a device configured to sense the positioning of print device 120 relative to housing 114 and an underlying medium. In the particular embodiment illustrated, position sensor 122 includes an encoder strip 222 and reader 224. Encoder strip 222 constitutes a strip of readable material coupled to housing 114 along guide 116. Reader 224 is coupled to print device 120 so as to move with print device 120 along axis 180 and so as to read or sense the position identifying indicia provided along strip 222. In one embodiment, strip 222 and reader 224 cooperate in an optical manner to sense the positioning of print device 120 along axis 180. In other embodiments, strip 222 and reader 224 may cooperate in other manners to sense the positioning of print device 120. For example, in another embodiment, strip 222 and reader 224 may alternatively cooperate in a magnetic manner to indicate positioning print device 120. In still other embodiments, position sensor 122 may constitute other sensing devices or arrangements. The detected positioning of print device 120 by sensor 122 is transmitted to controller 130 to assist controller 130 in controlling print device 120.

Power source 124 constitutes a source of power for controller 130 and potentially print device 120. In the particular example illustrated, power source 124 includes power supply board 226, internal power supply 228 and external power interface 230. Power supply board 226 constitutes a circuit board configured to route and selectively transmit power from supply 228 and/or interface 230 to controller 130 and print device 120. Internal power supply 228 constitutes a power storage unit contained within printer 110 for supplying and storing power. In one embodiment, internal power supply 228 constitutes a lithium-ion battery. In other embodiments, internal power supply 228 may comprise other power storage structures.

External power interface 230 constitutes an interface configured to facilitate the connection of printer 110 to an external source of power, such as a DC power transformer. External power interface 230 enables printer 110 to be operated using power transmitted directly from an external power source or enables internal power supply 228 to be charged. In other embodiments, printer 110 may alternatively omit either power supply 228 or an external power interface 230.

Controller 130 constitutes a processing unit configured to generate control signals for directing the printing operations by print device 120. In the particular example illustrated, controller 130 generates such control signals based upon the sensed positioning of print device 120 as indicated by signals from position sensor 122 and based further upon input received from user interface 144. In the particular embodiment illustrated, controller 130 further generates control signals based upon data received from data interface 136 (shown in FIG. 2). In other embodiments, controller 130 may generate such control signals based upon other factors. For example, in one embodiment, controller 130 may alternatively generate control signals based upon a sensed position of manual actuation member 150 in lieu of a sensed positioning of print device 120.

Interconnect 132 constitutes one or more structures configured to transmit control signals from controller 130 to print device 120. In the particular embodiment illustrated, interconnect 132 is a flexible electrical circuit interconnecting controller 130 and print device 120. In the embodiment illustrated, interconnect 132 is supported, contained and guided by transmission 160. In other embodiments, interconnect 132 may be guided to print device 120 by other structures. Moreover, in other embodiments, interconnect 132 may comprise other structures or may be omitted wherein control signals from controller 130 are communicated to print device 120 in another fashion such as through wireless communications.

Data interface 136 (shown in FIG. 2) constitutes an interface device configured to facilitate transmission or input of image or printing data to printer 110 and to controller 130. In the particular embodiment illustrated, interface 136 constitutes a Universal Serial Bus (USB) port. In other embodiments, data interface 136 may comprise other structures facilitating input of data to printer 110. For example, in one embodiment, data interface 136 may include a wireless transmitter and/or receiver configured to communicate with an external source of printing data wirelessly. In still other embodiments, interface 136 may be omitted, wherein image or printing data is stored in a memory permanently associated with controller 130 or wherein the image data is stored on a computer readable memory that is portable and which may be inserted or removed from printer 110.

User interface 144 constitutes one or more devices configured to facilitate the input of instructions or data to printer 110 by an operator or user. Interface 144 may additionally provide information to the user of printer 110. In the particular example illustrated, user interface 144 includes power switch 234, display 236 and scroll controls 238, 240. Power switch 234 actuates the supply of power from power source 124 to controller 130 and further actuates controller 130 between an on state and an off state. Although power switch 234 is illustrated as a push button which may be used to toggle printer 110 between on and off states, power switch 204 may comprise other input mechanisms.

Display 236 is configured to display information to a user. In one embodiment, display 236 is configured to provide a user with a visual representation of an image, indicia, text and the like that may be printed. In the particular example illustrated, display 236 is further configured to present instructions and/or options to a user for selection. For example, in one embodiment, the memory of controller 130 may include multiple images (i.e., text, pictures and the like) from which a user may choose to be printed by printer 110. Controls 238 and 240 constitute push buttons enabling a user to scroll through such various printing options so as to select an image to be printed by printer 110. In other embodiments, display 236 and controls 238, 240 may be omitted or may have other configurations. In one embodiment, in lieu of interface 144 including a display 206, interface 144 may include various light emitting diodes or the like which are selectively illuminated to communicate information or options to a user.

Manual actuation member 150 constitutes one or more members movably coupled to housing 114 and configured to be manually depressed by a user's hand so as to receive force which is transmitted to print device 120 by transmission 160. In the particular embodiment illustrated, manual actuation member 150 slidably extends over and about upper end 202 of housing 114. In the particular example shown, manual actuation member 150 is retained to housing 114 by an internal projection 242 (shown in FIG. 3) slidably captured within an elongate channel 244 formed in housing 114 (shown in FIG. 2). Projection 242 and channel 244 cooperate to guide movement of manual actuation member 150 along axis 246 between a raised position (shown in FIGS. 3-5) and a lowered position (shown in FIG. 6). As shown by FIG. 3, axis 246 extends substantially perpendicular to axis 180. In other embodiments, manual actuation member 150 may have other configurations and may be movably coupled to housing 114 in other manners. For example, manual actuation member 150 may alternatively slide within housing 114. In still other embodiments, manual actuation member 150 may be provided by a button, pad or the like configured to be manually depressed or moved generally along axis 246.

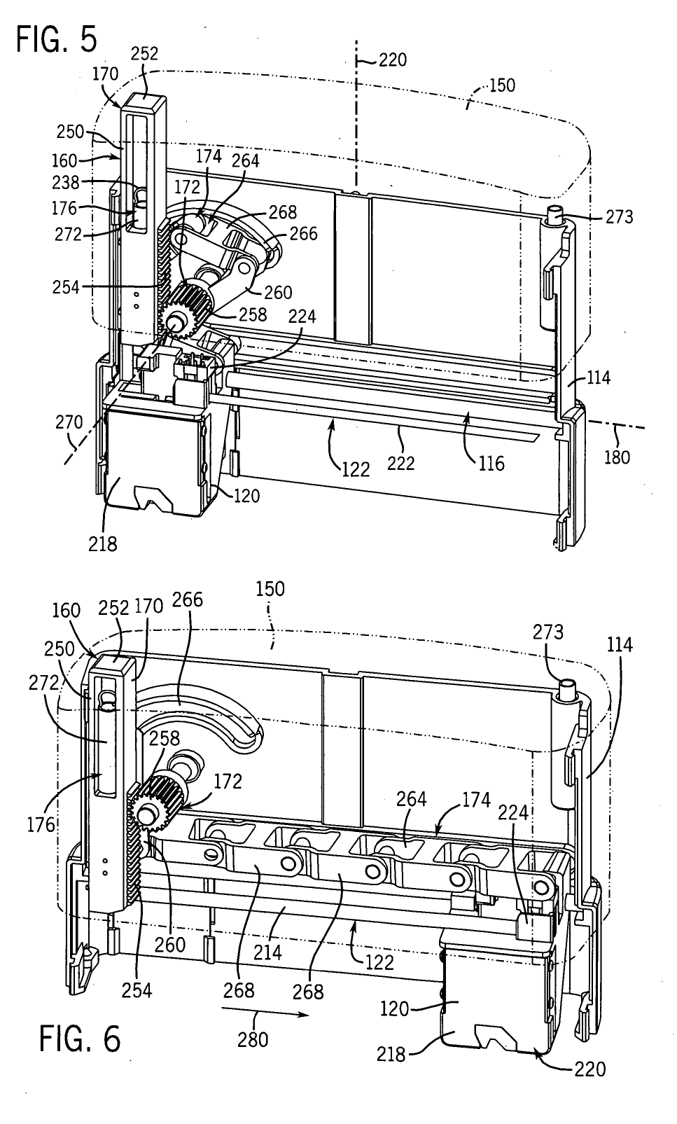

Transmission 160 constitutes one or more structures configured to transmit manually applied force from manual actuation member 150 to print device 120 so as to move print device 120 along axis 180. As shown by FIGS. 5 and 6, transmission 160 includes linear drive 170, rotary drive 172, linear drive 174 and return bias 176. Linear drive 170 constitutes one or more devices configured to transmit manual force applied to manual actuation member 150 to rotary drive 172. In the particular embodiment illustrated, linear drive 170 includes rack gear 250 slidably coupled to housing 114 and including an upper end 252 and a toothed portion 254. Upper end 252 is configured to be engaged and depressed by manual actuation member 150. Toothed portion 254 extends along a portion of rack gear 250 and is configured to mesh with rotary drive 172. Upon being engaged by manual actuation member 150, rack gear 250 moves or slides relative to housing 114 between a raised position (shown in FIGS. 3-5) and a depressed. or lowered position (shown in FIG. 6). Because rack gear 250 is slidably coupled to housing 114, manual actuation member 150 engages end 252 rather than being connected to rack gear 250. As a result, tolerances between housing 114 and manual actuation member 150 may be increased.

Rotary drive 172 constitutes one or more structures rotatably supported by housing 114 and configured to be rotatably driven by linear drive 170. Rotary drive 172 is further configured to transmit force to linear drive 174 upon being rotated such that print device 120 is moved or scanned along axis 180. In the particular example illustrated, rotary drive 172 includes a pinion gear 258 and arm 260. Pinion gear 258 is rotatably supported by housing 114 in meshing engagement with toothed portion 254 of rack gear 250. Arm 260 extends from pinion gear 258 and has an end coupled to linear drive 174. Upon downward depressment of rack gear 250, pinion gear 258 rotates so as to rotate arm 260 and to move linear drive 174. Although transmission 160 is illustrated as including rack gear 250 and pinion gear 258 having teeth that are intermeshed to transmit force, in other embodiments, rack gear 250 and pinion gear 258 may alternatively be replaced with similar members that omit such teeth, wherein such members frictionally engage one another to transmit force.

Linear drive 174 includes one or more members or structures configured to transmit and convert rotary motion or torque received from rotary drive 172 to print device 120 so as to linearly move print device 120 along axis 180. In the particular example illustrated, linear drive 174 includes flexible drive member 264 and guide or track 266. Flexible drive member 264 constitutes one or more structures which are flexible and interconnect arm 260 of rotary drive 172 and print device 120. In the particular example illustrated, flexible drive member 264 includes a plurality of rigid links 268 pivotally connected to one another to form a linkage. Track 266 is coupled to an inside of housing 114 and is configured to guide or direct movement of flexible drive member 264 as it is moved about axis 270 of pinion gear 258 to move print device 120 along axis 180. Although track 266 is illustrated as being integrally formed as part of a single unitary body with housing 114, track 266 may alternatively be coupled to housing 114 in other fashions.

Return bias 176 constitutes one or more structures or mechanisms configured to return print device 120 to its original home position upon release of manual actuation member 150. In the particular example illustrated, return bias 176 includes bias members 272 and 273. Bias member 272 constitutes a structure configured to resiliently bias rack gear 250 towards its raised position so as to also bias print device 120 to its original or home position shown in FIGS. 3-5. In the particular example illustrated, bias member 272 constitutes a tension spring having a first end (not shown) connected to rack gear 250 and a second end 275 connected to housing 114. During depressment of manual actuation member 150, rack gear 250 is moved towards the lowered position which results in bias member 254 being stretched or extended. Upon release of manual actuation member 150, bias member 238 returns to its original position, urging rack gear 250 and manual actuation member 150 to their raised positions which also results in print device 120 being returned to its original position. In the particular example illustrated, bias member 272 is contained or housed within rack gear 250. In other embodiments, bias member 272 may be provided at other locations and have other configurations.

Bias member 273 constitutes one or more structures configured to apply a bias force to additional portions of manual actuation member 150 such that an overall balanced force is applied to manual actuation member 150. Because bias members 272 and 273 are located substantially around and in close proximity to a perimeter of printer 110, a balanced biasing force is applied to manual actuation member 150 and internal space of printer 110 is conserved. In the particular example illustrated, bias member 273 comprises a compression spring supported by housing 114 on an opposite end of printer 110 as compared to bias member 272. In other embodiments, bias member 273 may comprise other bias members, may be located at other locations or may be omitted.

FIGS. 5 and 6 illustrate operation of printer 110. As shown by FIG. 6, upon depressment of manual actuation member 150, rack gear 250 is moved to its lowered position causing rotary drive 172 to rotate in a counter-clockwise (as seen in FIG. 6) to unwind flexible drive member 264 so as to apply force to print device 120 in the direction indicated by arrow 280. This results in print device 120 also being moved in the direction indicated by arrow 280 so as to scan print device 120 forward. Upon the user releasing or lifting manual actuation member 150, bias member 272 returns rack gear 250 and manual actuation member 150 to their original raised positions. Lifting of rack gear 250 rotates pinion gear 258 of rotary drive 172 in a clockwise direction to rewind flexible drive member 264 and to return print device 120 to its initial home position (shown in FIG. 5).

In the example illustrated, pinion gear 258 and arm 260 are configured to provide distance multiplication. In other words, pinion gear 258 and arm 260 of rotary drive 172 are configured such that depressment of manual actuation member 150 by a first distance results in scanning or movement of print device 120 by a second greater distance. As a result, printing device 120 may be moved across a larger printing area with less corresponding movement of manual actuation member 150.

FIG. 7 illustrates printer 310, another embodiment of printer 110. Printer 310 is similar to printer 110 except that printer 310 includes linear drive 370 and rotary drive 372 in lieu of linear drive 170 and rotary drive 172, respectively. Linear drive member 370 is configured to transmit the linear force applied to manual actuation member 150 along axis 246 to rotary drive 372 so as to rotate drive 372. Linear drive 370 includes idler 382 and endless member 384. Idler 382 is rotatably supported by housing 114 and maintains endless member 384 in sufficient tension. Endless member 384 wraps about idler 382 and is in engagement with rotary drive 372. Endless member 384 is fixedly connected to a portion of manual actuation member 150 by connector 385.

Rotary drive 372 is similar to rotary drive 172 except that pinion gear 258 is wrapped about by endless member 384. In other embodiments, rotary drive 372 may include a pulley, in lieu of gear 258, about which endless member 384, constituting a belt or toothed belt, wraps. In yet another embodiment, rotary drive 374 may include a sprocket, in lieu of gear 258, about which endless member 384, constituting a chain, wraps about. Like rotary drive 172, rotary drive 372 includes an arm 260 having an end portion connected to flexible drive member 288.

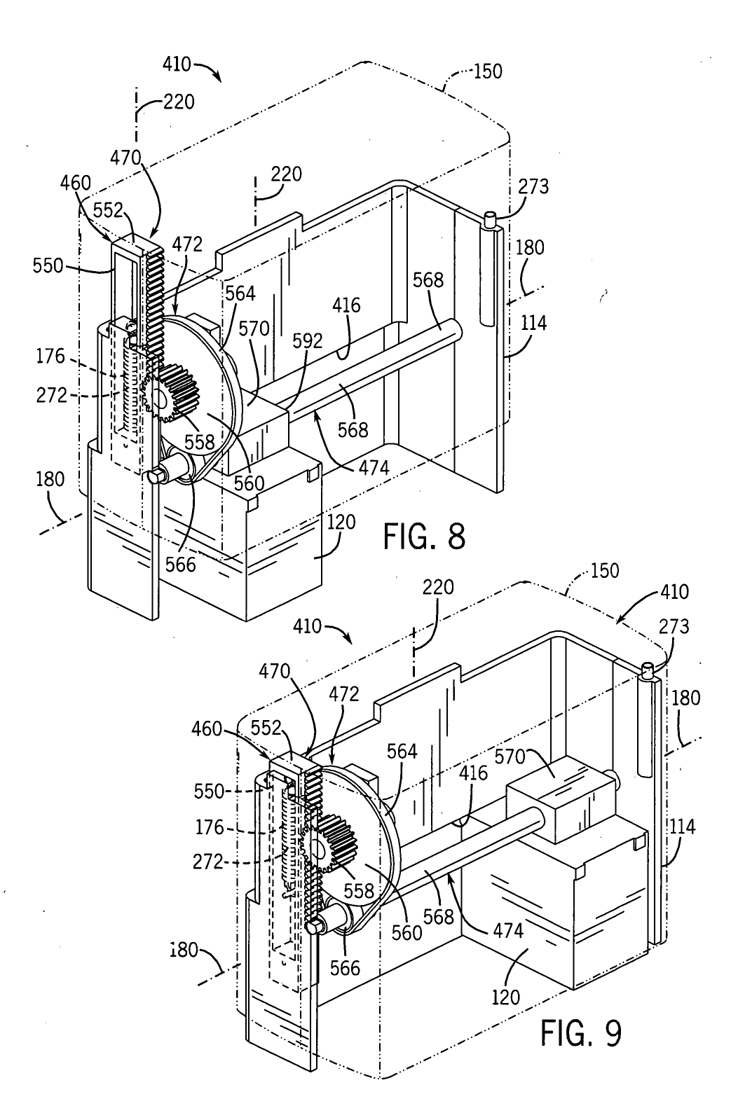

FIGS. 8 and 9 illustrate printer 410, another example embodiment of printer 10. Printer 410 is similar to printer 110 except that printer 410 includes guide 416 and transmission 460 in lieu of guide 116 and transmission 160, respectively. Those remaining components of printer 410 which are similar to corresponding components of printer 110 are numbered similarly. Printer 410 includes power source 124, controller 130, data interface 136 and user interface 144 which are shown and described in FIGS. 3 and 4 with respect to printer 110, but which are not shown in FIGS. 8 and 9 for ease of illustration. Guide 416 directs movement of print device 120 linearly along axis 180. In the particular example illustrated, guide 416 constitutes a shelf on each side of housing 114 so as to engage print device 120 and to guide movement of print device 120 along axis 180. In other embodiments, guide 416 may have other configurations.

Transmission 460 transmits force resulting from depressment of manual actuation member 150 to print device 120 to move print device 120 along axis 180. Transmission 460 includes linear drive 470, rotary drive 472, linear drive 474, and return bias 176. Linear drive 470 transmits linear force applied to manual actuation member 150 to rotary drive 472. In the particular example illustrated, linear drive 470 constitutes a rack gear 550 slidably coupled to housing 114 for movement between a raised position (shown in FIG. 8) and a lowered position (shown in FIG. 9). In other embodiments, linear drive 470 may comprise a rack gear connected or affixed to manual actuation member 150. In still other embodiments, linear drive 470 may have other configurations such as linear drive 370 shown in FIG. 7.

Rotary drive 472 constitutes one or more members rotatably supported by housing 114 between linear drive 470 and flexible drive member 564 of linear drive 474. Rotary drive 472 is configured to be rotatably driven by movement of linear drive 470 so as to drive linear drive 474. In the particular example illustrated, rotary drive member 580 includes pinion gear 558 and pulley 560. Pinion gear 558 is coupled to pulley 560 and is in meshing engagement with the rack gear 550 of linear drive 470. Pulley 560 is coupled to pinion gear 558 and has a diameter greater than the diameter of pinion gear 558. As a result, transmission 460 provides distance multiplication such that depressment of manual actuation member 150 by a first distance along axis 246 results in print device 120 being moved along axis 180 by a second greater distance. Although transmission 460 is illustrated as including rack gear 550 and pinion gear 558, in other embodiments, linear drive 470 may alternatively include structures substantially identical to rack gear 550 and pinion gear 558, wherein such structures omit teeth and rely upon frictional engagement for transmitting force therebetween.

Linear drive 474 constitutes one or more structures or mechanisms configured to transmit and convert rotational force or torque from rotary drive 472 to print device 120 so as to move print device 120 along axis 180. In the particular example illustrated, linear drive 474 includes flexible drive member 564, pulley 566, lead screw 568 and nut 570. Flexible drive member 564 transmits force from pulley 560 of rotary drive 472 to lead screw 568 and ultimately to print device 120. Flexible drive member 564 constitutes a belt wrapped about pulley 560 and engaging a pulley 566 coupled to lead screw 568. In this embodiment, any number of suitable flexible drive members may be used such as, but not limited to, flat, round, “V” profile and timing belts. In other embodiments, transmission 460 may include other components in lieu of pulley 560 and flexible drive member 564. For example, in other embodiments, transmission 460 may alternatively include sprockets in lieu of pulleys 550 and 566, wherein flexible drive member 564 alternately comprises a chain. In yet other embodiments, transmission 460 may alternatively include one or more gears forming a gear train between pinion gear 558 and lead screw 568. In such an embodiment, flexible drive member 564 may be omitted.

Lead screw 568 is an elongate screw rotatably supported by housing 114 substantially along axis 180. Nut 570 threadably engages the external threads of lead screw 590 and is coupled to print device 120, the rotation of which is inhibited by the shoulder provided by guide 416 and a similar one (not shown) on the opposite side of the case. As a result, rotation of lead screw 568 results in nut 570 and print device 120 moving along lead screw 568 and along axis 180. Alternatively, other types of male/female features on the print device and the case or other support structure of the device may be employed.

In operation, the depressment of manual actuation member 150 causes manual actuation member 150 to engage end 552 so as to apply force to rack gear 550 and to move rack gear 550 to the lowered position shown in FIG. 9. Lowering of rack gear 550 results in force being transmitted to rotary drive 472. Rotation of pinion gear 558 and pulley 560 results in transmission of torque to lead screw 568 by flexible drive member 564. As a result, lead screw 568 rotates to move and scan nut 510 and print device 120 along axis 180 from the position shown in FIG. 8 to the position shown in FIG. 9.

Upon release of manual actuation member 150, bias members 272 and 273 of return bias 176 (described above with respect to printer 110) urge linear drive member 530 and manual actuation member 150 to their raised positions. As a result, pinion gear 558 and pulley 560 are rotatably driven in an opposite direction. This results in lead screw 568 being rotated in an opposite direction such that print device 120 moves along axis 180 to its initial home position shown in FIG. 8.

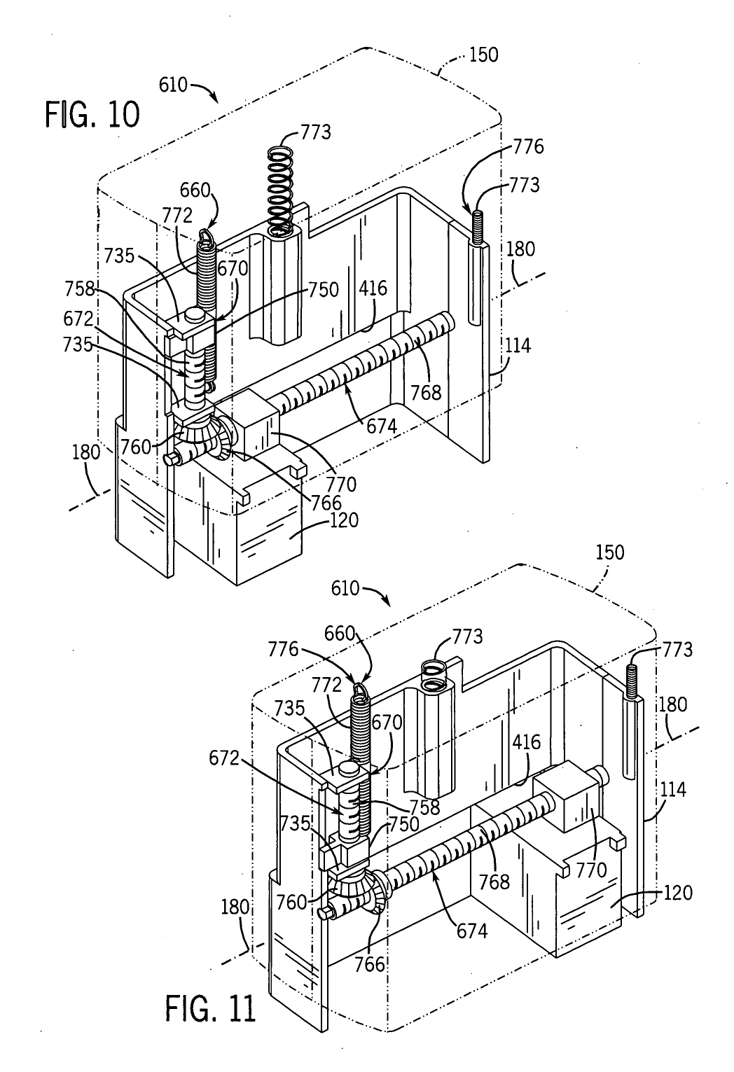

FIGS. 10 and 11 illustrate printer 610, another embodiment of printer 10. Printer 610 is similar to printer 410 except that printer 610 includes transmission 660 in lieu of transmission 460. Those remaining components of printer 610 which correspond to components of printer 410 are numbered similarly. Printer 610 includes power source 124, controller 130, data interface 136 and user interface 144 which are shown and described in FIGS. 3 and 4 with respect to printer 110, but which are not shown in FIGS. 10 and 11 for ease of illustration. Transmission 660 generally includes linear drive 670,. rotary drive 672, linear drive 674 and return bias 676. Linear drive 670 constitutes a device configured to transmit linear force applied by depressment 150 to rotary drive 672. In the particular example illustrated, linear drive 670 includes a nut 750 coupled to manual actuation member 150 so as to move up and down with manual actuation member 150. Nut 750 moves between a raised position shown in FIG. 10 and a lowered position shown in FIG. 11.

Rotary drive 672 constitutes one or more structures operably coupled between linear drive 670 and linear drive 674 so as to transmit force therebetween. Rotary drive 672 is configured to be rotatably driven in response to linear movement of linear drive 670. In the particular embodiment illustrated, rotary drive 672 includes lead screw 758 and bevel gear 760. Lead screw 758 is rotatably supported by supports 735 which extend from housing 114. Lead screw 758 threadably engages nut 750 and terminates at beveled gear 760. Bevel gear 760 engages linear drive 674.

Linear drive 674 constitutes a drive mechanism configured to transmit torque supplied to it by rotary drive 672 into linear force so as to move print device 120 along axis 180. In the particular example illustrated, linear drive 674 includes bevel gear 766, lead screw 768 and nut 770. Bevel gear 766 is in meshing engagement with bevel gear 760 such that torque from lead screw 758 of rotary drive 672 is transmitted to bevel gear 766 and to lead screw 768. Lead screw 768 is rotatably supported by housing 114 substantially along axis 180. Nut 770 threadably engages lead screw 768 and is coupled to print device 120.

Return bias 676 constitutes one or more structures configured to resiliently bias transmission 660 and print device 120 to their home positions shown in FIG. 10. In the particular example illustrated, return bias 676 includes bias members 772 and 773. Bias members 772 and 773 constitute mechanisms configured to resiliently bias or urge manual actuation member 150 towards its raised position (shown in FIG. 10). In one embodiment, bias member 772 comprises a tension spring having a first end affixed to housing 114 and a second opposite end affixed to nut 750. Bias member 773 comprises a compression spring positioned between housing 114 and manual actuation member 150 on an opposite side or corner to that of member 772. Depressment of manual actuation member 150 results in the tension spring of bias member 772 being extended and the compression spring of bias member 773 being compressed. Because bias members 772 and 773 are located substantially around and in close proximity to a perimeter of printer 610, a balanced biasing force is applied to manual actuation member 150 and internal space printer 610 is conserved.

In other embodiments, printer 610 may include other springs having other configurations and locations for resiliently biasing manual actuation member 150 to its raised position and for urging print device 120 to its home position (shown in FIG. 10). For example, in another embodiment, return bias 676 may alternatively include one or more centrally located compression springs captured between housing 114 and manual actuation member 150. FIGS. 10 and 11 illustrate one example of such a compression spring 773′ in phantom. In the particular example shown, return bias 676 would additionally include a second such spring 773′ directly opposite to the spring 773′ illustrated in FIGS. 10 and 11.

As shown by FIGS. 10 and 11, depressment of manual actuation member 150 results in force being applied to the nut 750 of linear drive 670 to move the nut 750 to its lowered position shown in FIG. 11. Lowering of the nut 750 results in lead screw 758 of rotary drive 672 being rotatably driven to rotate bevel gear 760. Rotation of bevel gear 760 rotates bevel gear 766 to rotatably drive lead screw 768. Rotation of lead screw 768 results in nut 770 and print device 120 being scanned or moved along axis 180 to the position shown in FIG. 11.

Upon release of manual actuation member 150, bias member 752 urges the nut 750 of linear drive 670 towards its raised position shown in FIG. 10. This results in the lead screw 758 of rotary drive 672 and lead screw 768 of linear drive 674 being rotated in opposite directions such that nut 770 and print device 120 return to their home positions shown in FIG. 10.

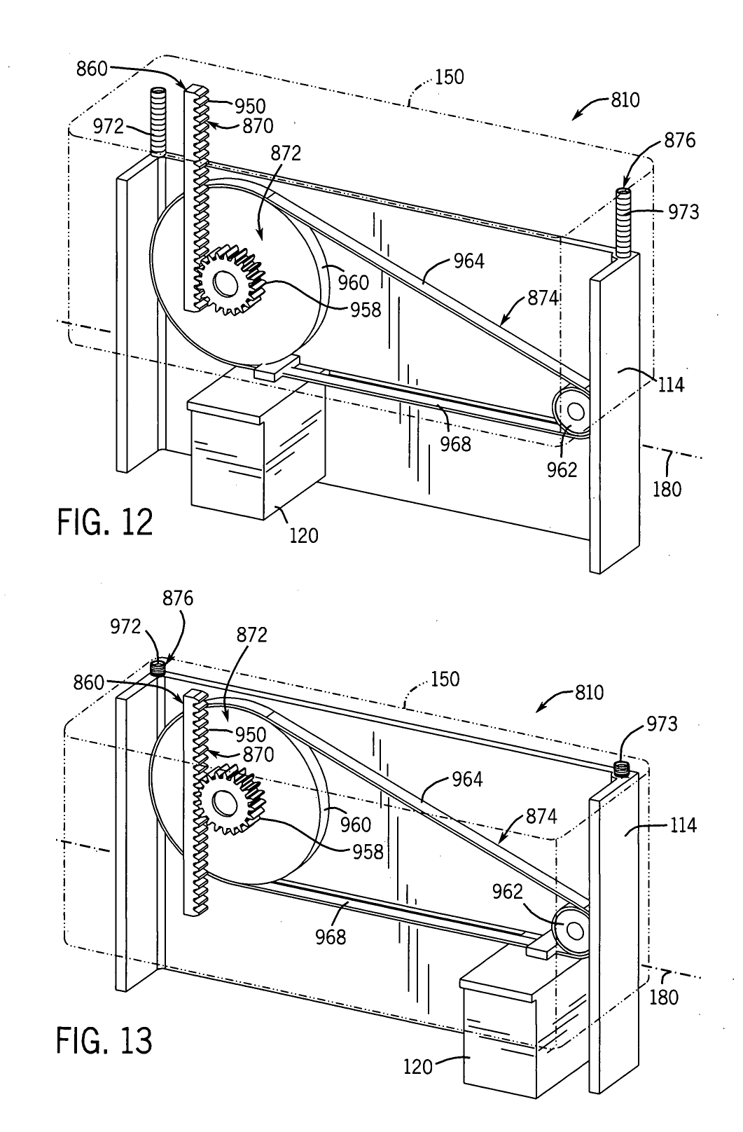

FIGS. 12 and 13 illustrate printer 810, another embodiment of printer 10. Printer 810 is similar to printer 410 except that printer 810 includes transmission 860 in lieu of transmission 460. Printer 810 includes power source 124, controller 130, data interface 136 and user interface 144 which are shown and described in FIGS. 3 and 4 with respect to printer 110, but which are not shown in FIGS. 8 and 9 for ease of illustration. Transmission 860 generally includes linear drive 870, rotary drive 872, linear drive 874 and return bias 876. Linear drive 870 is configured to transmit linear force resulting from manual depressment of manual actuation member 150 to rotary drive 872. In the particular example illustrated, linear drive 870 includes a rack gear 950 affixed to manual actuation member 150. In other embodiments, rack gear 950 may be movably coupled to housing 114 and resiliently biased towards a raised position.

Rotary drive 872 includes one or more members configured to be rotatably driven in response to force being applied to linear drive 870. In the particular example illustrated, rotary drive 872 includes pinion gear 958 and pulley 960. Pinion gear 958 and pulley 960 are rotatably supported by housing 114. Pinion gear 958 is in meshing engagement with rack gear 950. Pulley 960 is fixedly coupled to pinion gear 958 and is in engagement with linear drive 874. Pulley 960 has an enlarged diameter as compared to that of pinion gear 958. As a result, transmission 860 provides distance multiplication such that depressment of manual actuation member 150 by a first distance results in print device 120 being linearly moved along axis 180 by a second greater distance. Although transmission 860 is illustrated as including rack gear 950 and pinion gear 958, in other embodiments, transmission 860 may alternatively include structures substantially similar to rack gear 950 and pinion gear 958 except that such structures omit inner meshing teeth, wherein such structures frictionally engage one another to transmit force therebetween.

Linear drive 874 includes one or more members or structures connected to rotary drive 872 and configured to convert torque of rotary drive 872 to linear force so as to move print device 120 along axis 180. In the particular example illustrated, linear drive 874 includes idler 962 and flexible drive member 964. Idler 962 comprises an idling member rotatably supported by housing 114 on an opposite side of housing 114 to pulley 942. Idler 962 assists in maintaining flexible drive member 964 in tension and supporting span 968 of flexible drive 964 substantially along axis 180.

Flexible drive member 964 comprises an endless member such as a belt extending about pulley 960 and idler 962. Span 968 of member 964 is affixed to print device 120. Although rotary drive 872 is illustrated as including pulley 960 while flexible drive member 964 is described as including an endless member constituting a belt, in other embodiments, pulley 960 and idler 962, 946 may alternatively constitute sprockets while member 964 constitutes a chain. In particular embodiments, pulley 960 and idler 962 and flexible drive member 964 may comprise toothed pulleys and a toothed belt, respectively.

Return bias 876 constitutes one or more mechanisms or members configured to resiliently bias or urge manual actuation member 150 to its raised position and to urge transmission 860 and print device 120 to their home positions shown in FIG. 10. In the particular example illustrated, return bias 876 includes bias members 972 and 973. Bias members 972 and 973 constitute springs or other mechanisms configured to resiliently bias manual actuation member 150 and rack gear 950 towards a raised position. In the particular example illustrated, bias members 972 and 973 comprise compression springs captured between housing 114 and manual actuation member 150 in opposite corners. As a result, springs 972 and 973 apply a balanced or symmetric biasing force to manual actuation member 150. At the same time, because springs 972 and 973 are located along a perimeter of printer 610, valuable internal space of printer 610 is conserved. In other embodiments, bias members 972 and 973 may comprise other forms of springs and may be provided at other locations.

FIGS. 12 and 13 illustrate the operation of printer 810. As shown in FIG. 12, bias members 972 and 973 resiliently biases manual actuation member 150 towards a raised position such that print device 120 is in a home position as shown. As shown by FIG. 13, upon depressment of manual actuation member 150, rack gear 950 of linear drive 870 is driven in a downward direction so as to rotatably drive rotary drive 872. The rotation of pinion gear 958 and pulley 960 results in flexible drive member 964 of linear drive 874 being driven about pulley 960 and idler 962 such that print device 120 is moved from the position shown in FIG. 12 to the position shown in FIG. 13. Upon release of manual actuation member 150, bias members 972 and 973 return manual actuation member 150 to its original position shown in FIG. 12. This results in rack gear 950 being moved to its raised position and further results in rotary drive 872 being driven in an opposite direction to drive flexible drive member 964 in an opposite direction to return print device 120 to the original home position shown in FIG. 12.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A printer comprising:
a print device;
an actuation member; and
a flexible drive member operably coupled between the print device and the actuation member to apply force to the print device to displace the print device in response to depressment of the actuation member.

2. The printer of claim 1, wherein the flexible drive member is operably coupled between and to the print device and the actuation member to move the print device by a first greater distance in response to depressment of the actuation member by a second lesser distance.

3. The printer of claim 1 further comprising a rack gear configured to move in response to depressment of the actuation member.

4. The printer of claim 3 further comprising a housing, wherein the rack gear is movably connected to the housing.

5. The printer of claim 4, wherein the actuation member engages an end of the rack gear.

6. The printer of claim 4, wherein the rack gear is attached to the actuation member.

7. The printer of claim 4, wherein the rack gear is configured to move from a raised position to a lowered position in response to depressment of the actuation member and wherein the printer further comprises a spring within the rack gear configured to resiliently bias the rack gear towards the raised position.

8. The printer of claim 1, wherein the flexible drive member includes a linkage.

9. The printer of claim 8 further comprising a flexible electrical connection electrically connected to the print device and supported by the linkage.

10. The printer of claim 1, wherein the flexible drive member includes a belt.

11. The printer of claim 1 further comprising:
a nut non-rotatably coupled to the print device; and
a screw engaging the nut, wherein depressment of the actuation member rotates the screw.

12. The printer of claim 1, wherein the flexible member includes a belt and wherein the printer further comprises a pulley engaging the belt, wherein the depressment of the actuation member rotates the pulley.

13. The printer of claim 1 further comprising:
a rack gear configured to move in response to depression of the actuation member; and
a pinion gear, wherein the flexible drive member connects the pinion gear to the print device.

14. The printer of claim 1 further comprising:
a housing; and
one of a groove and projection connected to the print device and the other of the groove and the projection connected to the housing, wherein the projection is received within the groove to movably support the print device.

15. The printer of claim 14, wherein said other of the groove and the projection is integrally formed as part of a single unitary body with the housing.

16. The printer of claim 1, wherein the print device includes an inkjet printhead.

17. The printer of claim 1, wherein the manual depression member moves along a first axis and wherein the print device linearly moves along a second axis substantially perpendicular to the first axis.

18. The printer of claim 1, further comprising:
one or more bias members located substantially around and in close proximity to a perimeter of the actuation member to resiliently bias the actuation member towards a raised position.

19. A printer comprising:
a print device;
an actuation member; and
a rotary member configured to rotate in response to depressment of the actuation member such that rotation of the rotary member linearly moves the print device.

20. The printer of claim 19, wherein the rotary member comprises a pinion gear and wherein the printer further comprises a rack gear in engagement with the pinion gear.

21. The printer of claim 20, wherein the rack gear is configured to move from a raised position to a lowered position in response to depressment of the actuation member.

22. The printer of claim 21 further comprising a housing, wherein the rack gear is movably supported by the housing.

23. The printer of claim 19 further comprising a flexible drive member operably coupling the rotary member and the print device.

24. The printer of claim 23, wherein the flexible member comprises a belt carrying the print device.

25. The printer of claim 23, wherein the flexible member is endless.

26. The printer of claim 23, wherein the flexible member includes a link.

27. The printer of claim 23 further comprising:
a nut non-rotatably coupled to the print device; and
a screw engaging the nut, wherein rotation of the rotary member rotates the screw.

28. The printer of claim 19, wherein the rotary member is operably coupled to the print device such that depressment of the actuation member a first distance linearly moves the print device a second greater distance.

29. A printer comprising:
an actuation member;
a print device;
a first linear drive configured to transmit force applied to the actuation member along a first axis;
a rotary drive configured to be rotatably driven by the first linear drive; and
a second linear drive configured to transmit and convert torque from the rotary drive to the print device to move the print device along a second axis non-parallel to the first axis.

30. A printer comprising:
a print device;
an actuation member; and
means for applying force to the print device with a flexible member operably coupled between the print device and the actuation member to displace the print device in response to depressment of the actuation member.

31. A method comprising:
applying force to an actuation member; and
transmitting the force from the actuation member to a print device using a flexible member operably coupled between the actuation member and the print device to displace the print device.

32. The method of claim 31, wherein application of force to the actuation member moves the actuation member a first distance and wherein the force is transmitted to the print device so as to move the print device a second greater distance.

33. A printer comprising:
a housing;
a print device;
an actuation member operably coupled to the print device and moveably coupled to the housing for movement between a raised position and a depressed position so as to displace the print device; and
at least one bias member operably coupled between the housing and the actuation member along a perimeter of the housing, wherein the at least one bias member resiliently biases the actuation member towards the raised position.
